(19) United States
(12) Patent Application Publication
(10) Pub. No.: US 2020/0202737 A1
(43) Pub. Date: Jun. 25, 2020

(54) AUTOMATED SYSTEM FOR MAPPING ORDINARY 3D MEDIA AS MULTIPLE EVENT SINKS TO SPAWN INTERACTIVE EDUCATIONAL MATERIAL

(71) Applicant: Appearition Private Limited, Melbourne (AU)

(72) Inventor: Vivek Aiyer, Melbourne (AU)

(21) Appl. No.: 16/716,587

(22) Filed: Dec. 17, 2019

(30) Foreign Application Priority Data
Dec. 17, 2018 (IN) 201841047773

(51) Int. Cl. G09B 7/00; G06Q 50/20; G06Q 10/10; G06F 40/40; G06K 9/00; G06T 13/20; G06F 3/01; G06T 19/20

(52) U.S. Cl. CPC G09B 7/00; G06Q 50/205; G06Q 10/10; G06T 19/20; G06K 9/00718; G06T 13/20; G06F 3/011; G06F 40/40

(57) ABSTRACT

A method of transforming 3D models or animations into 3D educational objects for providing educational experiences addressing personalised learning paths of students or trainees is provided. The method comprises converting (1500) the 3D models or animations into the 3D educational objects. The 3D educational objects are treated as a primary object to which sets of interactable digital assets provisioned by the Learning Phase Generator; transforming (1502) the conventional 2D or 3D digital assets to the 3D educational objects by implementing real time learning object modification; and associating (1504) learning information that comprises the 3D educational objects with specific locations on a surface of the primary object.

### BACKGROUND

### Technical Field

The present disclosure relates to a system that produces real time editable, centrally managed, educational experiences addressing personalised learning paths via usage of 3D models or animations. The 3D models or animations are processed by the system to spawn any number and type of external digital material, including educational packages provisioned by the system, to present the user with Augmented Reality (AR), Virtual Reality (VR) or Mixed Reality (MR) experiences that can support the fundamental principles of learning phases as espoused by a number of knowledge acquisition models. The present disclosure provides a method to Centrally Automate the Staging of Three-D models as Data Models (CASTMDM) inclusive of incorporating interactive learning materials. More particularly, the present disclosure addresses personalised learning paths via gamification to evidence learning through semi-automated interactives, signalling educationally valid feedback with immersive playback and reporting capabilities.

### Description of the Related Art

There is a vast array of learning systems, which comply with the definition of being mainly a “software application for the administration, documentation, tracking, reporting and delivery of educational courses or training programs (https://en.wikipedia.org/wiki/learning_management_system). However, most of these systems are based on on-line courses that mainly deliver non-virtual experiences.

In terms of those systems that do deliver virtual training simulations, or virtual reality learning experiences, the barrier that remains is the lack of appropriate content, or rather the difficulty and expense required to create or modify such content.

Another issue, at least on the short term, is that VR gear is still perceived as expensive, or cumbersome, so many 3D interactive models must be constructed to also play in standard computers or mobile devices, adding complexities to the build, since many of these examples are produced as stand-alone client-based solutions.

In the continuing gap caused by prior art's failure to provide a scalable solution that provisions the means to utilize already existing digital material as interactive learning experiences, in AR or VR mode, within the present infrastructure of low cost mobiles and computers, but also scalable to any form of specialized AR or VR gear, the present disclosure tackles both critical problems by standardizing and significantly lowering the technical knowledge required to create immersive learning content from already existing material and delivering the outputs into either non-specialised hardware or AR/VR specialist hardware without requiring direct changes to the already designed learning modules.

It is also evident that the many advantages that AR and VR can provision utilising data visualisation techniques are omitted by current commercial software targeting educational/training requirements. Without the methods or means to calculate or display learning outcomes as a measure of success other than as summative assessments based on final gradings, the learning process as an adventure in exploration, discovery, learning, and integration to generate new useful generalisations, is often nebulous to the student and teacher alike. The present disclosure proposes to explore this gap, by providing the measuring tools that will plot the habits of students/trainees when exploring and manipulating learning objects; and how teachers and content managers can “re-play” learning path patterns as immersive AR or VR experiences, to highlight outstanding exemplars against samplings with lower or unacceptable success rates, thus exposing the learning paths optimally suited for subsuming the subject matter.

Accordingly, there is a need for implementing a centrally managed system to produce AR or VR enabled andragogical experiences; produced or modified from already existing digital content in a significantly reduced technical environment; addressing personalised learning paths via gamification to evidence learning through semi-automated interactives; signalling educationally valid feedback with immersive playback and reporting capabilities that addresses or at least ameliorates one or more of the aforementioned problems of the prior art and/or provides a consumer with a useful or commercial choice.

### SUMMARY

Below table indicates list of acronyms used in the present disclosure for immediate reference of the reader:

| | |
|---|---|
| API | Application Programming Interface |
| AR | Augmented Reality |
| BASS | Background Application Synching Service |
| CASTMDM | Centrally Automate the Staging of 3D models as Data |
| | Models |
| CCAM | Course Channel Administrator Module |
| CMM | Content Management Module |
| CLNDE | Central Learning Nodes Design Editor module |
| DAQE | Digital Asset Query Engine |
| ESDM | Educational Skin Data Model |
| GPS | Global Positioning System |
| HTTPS | Hypertext Transfer Protocol for secure communication |
| ID | Identifier |
| JSON | JavaScript Object Notation |
| JSON | A file or text structure that contains json objects, |
| PACKAGE | json arrays, or a mixture of both. |
| LFRPHI | Level of Focus Relevance by Phase and Item |
| LMHA | Learning Monitoring and Habit Assessment component |
| LPE | Learning Phase Editor |
| LPEval | Learning Process Evaluator |
| LPG | Learning Phase Generator |
| MR | Mixed Reality |
| OBJ | OBJ or .OBJ is a geometry definition file format first |
| | developed by Wavefront Technologies. The file format is |
| | open licensed and has been adopted by other 3D graphics |
| | application vendors. |
| QAM | Question and Answers Module |
| QADM | Question and Answers Data Model |
| SLAM | Simultaneous Localization and Mapping |
| TCP/IP | Internet protocol suite. Known as TCP/IP referencing |
| | Transmission Control Protocol and the Internet Protocol |
| UK | United Kingdom |
| URL | Uniform Resource Locator: a protocol for specifying |
| | addresses on the Internet |
| UV | UV, or UV mapping is the 3D modelling process of |
| | projecting a 2D image to a 3D model's surface for |
| | texture mapping |
| VR | Virtual Reality |

An objective is therefore to provide a centrally managed system to produce Augmented Reality or Virtual Reality enabled andragogical experiences; produced or modified from already existing digital content in a significantly reduced technical environment. A further objective is to provide a method to calculate or display learning outcomes as a measure of success other than as summative assessments based on final gradings.

The herein mentioned objectives are achieved with a system for automatically transforming 3D models or animations into 3D educational objects and a method of transforming 3D models or animations into 3D educational objects for providing educational experiences addressing personalised learning paths of students or trainees, according to the appended examples.

According to an aspect to the disclosure, a system for automatically transforming 3D models or animations into 3D educational objects for providing educational experiences addressing personalised learning paths of students or trainees is provided. The system comprises: a Learning Phase Generator that converts said 3D models or animations into said 3D educational objects, wherein said 3D educational objects are treated as a primary object to which sets of interactable digital assets are provisioned by the Learning Phase Generator; and a central learning nodes design editor module that implements real time learning object modification that transforms said conventional 2D or 3D digital assets to said 3D educational objects, said Learning Phase Generator associates learning information that comprises said 3D educational objects with specific locations on a surface of said primary object, wherein said Learning Phase Generator re-packages said 3D educational object with necessary associations of event triggers and media projection points to make up a contextual educational skin for said 3D educational object, and wherein said educational skin represents a virtual wrapping of said 3D educational object with a mesh of local points anywhere in proximity or contact with said 3D educational object responsive to virtual touching events, whether through screen touch/click capture or camera captured appropriate gestures.

According to a further aspect of the disclosure, a method of transforming 3D models or animations into 3D educational objects for providing educational experiences addressing personalised learning paths of students or trainees is provided. The method comprises converting said 3D models or animations into said 3D educational objects, wherein said 3D educational objects are treated as a primary object to which sets of interactable digital assets provisioned by the Learning Phase Generator; transforming said conventional 2D or 3D digital assets to said 3D educational objects by implementing real time learning object modification; and associating learning information that comprises said 3D educational objects with specific locations on a surface of said primary object.

Generally, embodiments of the present disclosure relate to provide a system to centrally manage, andragogical experiences, through a CASTMDM component. The present disclosure addresses personalised learning paths via gamification to evidence learning through semi-automated interactives, signalling educationally valid feedback with immersive playback and reporting capabilities.

The CASTMDM system, via its Learning Phase Generator, LPG, subcomponent acts on a range of 3D commercial compliant digital media formats, whereas formats not native to the LPG sub-system can be transformed by third party tools into acceptable formats. The primary 3D objects and animations are treated as base objects to which sets of interactable digital assets provisioned by the LPG subcomponent are provided, initially in a dormant state, that are later awakened or left undisturbed, as per configuration options managed by the educator/matter expert, whose roles as content developer/administrator of the system is made possible by the editing component of the LPG, referenced as the Learning Phase Editor, LPE.

The CASTMDM system works by referencing a data framework establishing a data node distribution, where sub-categories have a path to ascendants that spawned them, which permits the system to align each of its interactive elements to the appropriately catalogued and categorized learning feature request, either by direct reference, or by reference to the nested relationship of any part of the domain (i.e. as a default behaviour or property, the closest non-empty behaviour or property node is a direct ascendant).

The CASTMDM component supports the requirements of self-assessment, system-based assessment, as well as matter-expert assessment and provides online and application tools to assist in developing many of the assessment tools in use.

Gamification as its highest conceptual model concerns itself with motivation (why), mastery (how), and triggers (where and when). The delivery of interactives, in any of its formats from 2D to MR experiences, as an adjunct of the learning experience, can be designed with the highest probability of gamification by the choice and interactive pathways integrated into the learning experience and the selected environment, local in the case of AR, or remote in the case of VR. Each node in the CASTMDM system can act as gamification trigger or event, resolving into many forms of game scenarios such as: Simulation games, mini games, narrative games, guessing games, cooperative games, puzzles, skill games, quests, treasure hunts, and others, all within their respective educational context.

The ability to develop highly engaging learning simulations within the domains of VR and MR by closely aligning gamification objectives with learning goals is provisioned by the disclosure's framework and content development and management workflow (as per principles expounded in: Pfeiffer, Essential Resources for Training and Human Resource Professionals, Engaging Learning, Clark N. Quinn, Designing e-Learning Simulation Games, 2005).

Further gamification and critical educational frameworks are addressed by the present disclosure in various aspects, including:

A Webb's Depth of Knowledge framework (addressing; recall and reproduction; Skills and Concepts; Short-term Strategic Thinking and Extended Thinking) by semi-automating the content creation cycle to assist in categorizing and linking topics to different ranges of learning difficulty or mastery levels.

The extension of simulations as cohort events that can be shared live via video streaming services, provisioned with synchronous chatting, can enhance exploration and learning, as peer feedback and self-assessment are jointly supported by the present disclosure.

The ability to record experiences and share them for communal consumption, extending the concept of student reflection as a form of re-iteration to gain improvement insights is also supported by the disclosure.

In acknowledging the crucial relationship of constructing well designed personalised learning path options to accommodate individual's learning styles, without weakening knowledge or skill requirements for any given learning objective, the disclosure addresses the value of relying on granular monitoring and reporting of the “virtual” journey undertaken by the user to transcend through each of the discovery, learning and evaluation phases of the learning objective. A level of reporting on the “virtual” journey that can measure which elements of the learning phases were sourced and which were missed (at least by not spending sufficient time or repetition to expedite learning) can be more valuable than just reporting on final grades.

The system also provides options to students/trainees to select “their” level of knowledge difficulty or depth, which integrates with Webb's four levels of learning principles, ensuring that each knowledge level begins by matching and proceeds to enhancing the current abilities of the student/trainee.

The present disclosure also supports the requirements of auto didacticism or self-education, by reinforcing learning through access to past learning decisions as personal progress reports and interactives. The CASTMDM system will provide a report on progress of the student/trainee for a given subject. This CASTMDM system further provides students auditing samples indicating learning habits via students using the application to replay their experiences, which can assist the student in selecting better learning habits to succeed in their learning quest.

Further, the system is made up of the administration and editing suite hosted as an on-line system, and its client applications, which relate to the integration of client application components, within an application framework that may run on different types of client devices including, mobiles and wearable devices that mainly provides a user interactivity and media generation functionality as centrally configured by a content management module as part of the on-line administration suite.

The administration and editing suite is composed of: a secured on-line portal layer, which executes the various administration or editing interfaces relevant to the roles and functions at play and transmits the necessary requests to service the requirements of the system, a Content Management Module; a multi-tenancy; and a multi-channel model that enables content to be managed as separate entities that belongs to different faculties, departments, or administrators, content managers, or educational developers, if so required; an Application Programming Interface (API) processing layer which responds to on-line requests by transmitting the necessary information to the central processing unit to co-ordinate the completion of such requests; a central processing unit, or central processor, that co-ordinates the usage of the other editing or administration layers; a Learning Phase Editor (LPE), which provides the means to edit various aspect relating to learning complexity and learning phase; a Question and Answers Module (QAM), which provides the means to generate different types of automated and non-automated assessment instances depending on the configuration selected by the administrator; An authentication layer that interacts with third party authentication providers to police role and credential usage within the system; a Central Learning Nodes Design Editor (CLNDE), which enables the administrator to visually inspect and make changes to the Educational Skin; a Digital Asset Query Engine (DAQE), which recurses through the text-based definition of a 3D object, such as the definition of an .Obj 3D formatted file, to capture in sequential order all defined individual vertex offsets; the UV mapping for each texture coordinate vertex; the faces that organise polygons into the object's list of vertices; texture vertices; vertex normals; and any other data as peripheral, and automatically uniquely classify the names of such nodes to provide the means to instantiate an Educational Skin on the original 3D Model or animation; an Internally Shared Memory that helps different layers to easily access the output of external processes; and a Central Storage, which includes any mix of SQL, non-SQL, or other data management implementations to centrally store digital artefacts that will be required in future sessions.

The typical client application or wearable device application developed with the client components of the present disclosure, would be composed of at least: a Client Application interface configured with visual options (menus, buttons, dialog boxes, and such like) to manage different aspects of the client application functionality and services; a Rendering Engine that includes one of any third party components that assists in the rendering of live-video and 3D objects and animations; an on-line API to access the on-line functions and services related to the normal functioning of the client application; a Learning Phase Generator (LPG), which manages projections and interactions given the phase and complexity level at play; a client version of the Question and Answers Module (QAM), which manages the parsing of questions, and the result feedback process; a Learning Monitoring and Habit Assessment Application Logger (LMHA), which logs information about the behaviour of the user in relationship to the learning or assessment activity at play; a Background Application Synching Service (BASS), a background service that synchs LMHA Data with the central on-line system; an upload/download service that post/gets information and data across the internet to and from the central on-line system respectively; and a Local Storage that the application system uses for appropriate purposes.

The Central Learning Nodes Design Editor module (CLNDE) implements real time learning object modification that transforms conventional 2D or 3D digital assets by adhering to publishing processes that are centrally authenticated and authorized to meet andragogical standards and conventions by the use of a Content Management Module (CMM) as depicted in FIG. 3. The configurations transformed or transmitted to this component, represented by the concept of an Asset Catalogue as depicted in FIG. 9, which is in essence a data array with a list of nodes of various data model configurations, is either directly edited through the on-line CLNDE user interface, or through an on-line editor sub-component, the LPE, to which its results orchestrate the functioning of the LPG in the client application, which re-packages 3D assets with the necessary associations of event triggers and media projection points to make up a contextual “educational skin” for the primary 3D object.

In an embodiment, the educational skin represents the virtual wrapping of a 3D object with a mesh of local points anywhere in proximity or contact with the 3D object, to which events will occur such as, virtual touching. The virtual touching represents touching an AR/VR projection at a specific point (whether through screen touch; articulated hand or eye tracking input retrieved through cameras; or pointer devices) or user input (through forms or other mechanisms) to produce a reaction. The educational skin represents projecting context based information in any digital format that is contextual relevant to the situation. This interactive learning artefact is therefore expanded and elucidated by the attachment of other media anchored to virtual locations and events configured by the administrator.

The LPE extends the CLNDE to enable the insertion of information through information contextual containers that, as a default, enable input into rolling sections conceptually encapsulated as: Complexity Level->Learning Phase->Primary Model->Anchor Points for Event Hooks and Activity Spawning.

The Digital Assets Query Engine (DAQE) that recursively queries digital items that are nominated as descendant objects spawned to n^{th} generations with the potential of sibling structures originating from any descendants, returning zero to many results depending on how the digital asset are already labelled, with any named node in the digital asset becoming a potential target, or becoming a candidate for actionable recommendation, for nesting the instructions that will be injected by the on-line system into the information and interaction layer of the CLNDE.

The Learning Process Evaluator (LPEval) module supports the requirements of auto didacticism by reinforcing learning through access to past learning decisions as personal progress reports and/or video interactives and fulfils the requirements of utilising discovery/exploration in both directed and undirected fashions (as per Sebastian B. Thrun,1992, Efficient Exploration in Reinforcement Learning), which enables content managers to provision any learning experience with exploration, learning and assessment cycles, or learning phases, with the possibility of some of these cycles being supported by a Question and Answers Module (QAM), such that:

a. The exploration cycle provides the learning content manager with the ability to filter the information managed by the CLNDE for usage within the exploration phase by automatically and appropriately redacting information as formulated in that phase when using the CLNDE. The QAM is also inactive in this cycle or may be used for student reflective purposes rather than assessment. In this instance, the assessment engine does not record the results of mini-tests as assessment activities, but rather as student reflections that the student can access to peruse feedback and results.

b. The learn cycle or learning phase provides the learning content manager with the ability to filter the information managed by the CLNDE, initially configured through the LPE component, for usage within the appropriate phase by automatically and appropriately redacting information as formulated in that phase when using the CLNDE. The QAM can be enabled by the content manager by toggling the option on. The content manager can create activities around other digital models, or parts of the main digital model, to focus learning on specific areas, if so desired. Non-assessment results are passed through the Learning Process Evaluator (LPE), which delivers appropriate immediate feedback about student progress at the end of the relevant activities.

c. The assessment cycle provides the learning content manager with the ability to filter the information managed by the CLNDE for usage within the assessment phase by automatically and appropriately redacting information as formulated in that phase when using the LPE. The QAM becomes active as the system centrally produces instructions for the client component to act on and create random tests and assessable activities and later relaying the resulting records of the tests. The results are passed through the LPE, which coordinates the appropriate immediate feedback and grading to the student at the end of tests by consolidating services provided by QAM.

The QAM further includes a set of algorithms relying on aspects of Natural Language Processing that when attached to visual components, fitted with the appropriate event call-backs, enables administrators/content managers using their designated ranges of gradings, to configure the run-time logic to statistically trigger system produced contextually valid evaluation statements in response to each answer supplied by the user/student involved in completing an assessment activity.

The QAM is also responsible for supplying the appropriate digital models and data to generate random questions aligned with the domain of the knowledge depth assigned. This may also include appropriate animations relevant to the question at hand. Components directly supporting this workflow include:

a. The Question and Answers Data Model, QDAM, as represented in FIG. 11, is configured by the administrator through the tools provided by the CLNDE which is queried and acted on by a set of algorithms. The QADM will be initialised in reference to parameters passed by the original state of the relevant visual components charged as learning objects, and made interactable in terms of VR or AR functionality through event triggers that marshal the expected behaviour of the AR or VR components through the pre-configured properties, whether default or custom administrator provisioned.

b. The set of algorithms that include Natural Language Processing and a hybrid recommender system, that when attached to visual components fitted with appropriate event call-backs, enables administrators/content managers to construct feedback templates. The feedback templates are used when students grading for any assessed activity reaches certain ranges. The feedback templates are used by the system to complete context specific feedback attached to student responses for each question that automatically focusses on deficiencies and strengths identified by the system through its scoring mechanism, which is serialised to a form as described in FIG. 11. In reference to the workings of this mechanism the data model Question Configuration, coordinated in part by the function Prepare Q&A List, enables the context for functions to limit the creation of multiple question sets to a maximum prescribed in Total Questions Per Type. The Question Type will be:

i. STUDENT_NAMES_PART; which relates to the system that randomly selecting a configured Asset Node Container node residing on the educational skin and presenting the corresponding highlighted visual component as an AR, VR or screen display with a question adjunct of the likes of “Name the part on display”. The student is expected to provide a free-text written input, which the system compares with the existing Asset Node Container Label, which is a text field in the data model Asset Node Container that denotes the correct response. Feedback for both correct and incorrect responses use string templates that are completed in reference to data retrieved from a query of the form detailed by Random Select Multiple Q&A Query as per FIG. 11.

ii. ADMINISTRATOR_WIZARD_INPUT; which relates to the system randomly generating a multiple question and answer assessment instance from data by utilising Random Select Multiple Q&A Query as per FIG. 11. As per expectations, there is a single correct answer, which is randomly selected from the Asset Node Container, records, specifically Asset Node Container Label; with a maximum set of plausible, but incorrect, answer options limited by the Total Incorrect Answers Per Type record in the Question Configuration data model; one of which is always the correct answer. Feedback for both correct and incorrect responses use string templates that are completed in reference to data retrieved from the earlier activated query Random Select Multiple Q&A Query.

iii. STUDENT_TOUCH_NAMED_PART; which relates to the system presenting the entire model to the student, with all named parts hidden, and randomly selecting a configured Asset Node Container node residing on the educational skin to formulate a question that prompts the student to touch the corresponding region on the Educational skin. The question is parsed with support from the query Random Select Multiple Q&A Query as per FIG. 11, which provides the necessary results to generate a question of the form; “Touch the [part name supplied by query]”. The student must respond by positioning the model in the correct configuration to access the region in question, and then touch the specific area that corresponds to the question. Feedback for both correct and incorrect responses use string templates that are completed in reference to data retrieved from the earlier activated query Random Select Multiple Q&A Query.

iv. ADMINISTRATOR_MANUAL_INPUT; which permits the administrator to configure instances of assessments with question and answer sequences manually entered by the administrator.

v. ADMINISTRATOR_BATCH_INPUT; which permits the administrator to configure instances of assessments of any of the forms already discussed through a .csv file that feeds the necessary configuration to the input data model Question Configuration, as described in FIG. 11.

It must be highlighted in utilising Learning Phase and Complexity Level contexts, and provisioning the extension of creating a pool of incorrect answers from aligned categories in Questions Configuration, such as: Use Siblings For Question Options; Use Parent For Question Options; Use Association For Question Option; or Use Antagonistic For Question Options provide plausible and yet incorrect answers, specifically suited for the domain of a question and multiple answers set, since the only correct answer is always in reference to the specific Asset Node Container Label in question and not near data or relationship neighbours.

c. The content manager configures the reinforcement language through the string templates for each grading range within an assessment instance, supplying strategies to reduce deficiencies and affirming effort when the student response reaches a favourable grading range; whilst the QAM identifies the level of reinforcement and subject that requires reinforcement, reducing the need for the content manager to design specific recommendations for every possible range of response from the student on every question. The automated tests templates are retrieved from the data model Feedback Templates as described in FIG. 11, also hook appropriate digital models and data, through the Container Learning Phase Complexity External Media Linkage, where the Media Type ID is the relationship which accesses such digital models and data in relationship to the Learner Phase ID, and Complexity Level ID context.

An LPE component, which provides students/trainees with evaluations on their progress at any point of the learning cycle as generated by sub components of the QAM, which also provision the possibility to generate micro certification, symbolised by digital trophies and awards that can be made visible to other students/trainees, to enhance intrinsic motivation by engaging the benefits of peer recognition (as elucidated in Brookfield, Stephen, 1995 Edition, McGraw-Hill Education (UK),Angus & Robertson, Adult Learners, Adult Education And The Community).

A Learning Monitoring and Habit Assessment component, LMHA, which via its data model, as represented in FIG. 10, provides the client application with the necessary interaction and triggers to generate AR or VR exploration/navigation maps that can be extrapolated to quantify relevant variables attached to measuring the degree to which knowledge or skills have been transferred. The data gathered is presented to both students and administrators as conventional reports tracking the progress of the student/trainee as well as the overall success of the course, which may be processed in at least two ways, but may include other processing possibilities:

a. The LMHA, equipped with the necessary interaction and triggers to generate AR or VR exploration/navigation maps, extrapolates to quantify various variables attached for measuring the degree to which knowledge or skills have been transferred, whilst sorting through individual exploration/navigation paths to ascertain the degree of learning success associated with the individual's selection of learning activities thus quantifying the degree of success for branches of exploration/navigation paths as qualified against their specific learning objectives.

b. The LMHA, via the construction of exploration/navigation maps quantified to signal the transfer of knowledge or skills that has occurred, can generate “outcome animations” or “outcome visualizations” of the different sequences of exploration/navigation paths that on average link to various levels of learning success, from lower to higher ranges as base-lined by the initial learning objectives. These “outcome interactives” are useful tools for content developers to understand what modifications should be made to their interactives to improve learning.

The Learning Nodes data model or the Asset Catalogue, as depicted in FIG. 9, is a core data structure compliant with the CLNDE and its sub-components. This data model is extended by the DAQE Module, where a variant data model configuration is used as represented by FIG. 11, whenever primary 3D objects require an “education skin” to be assigned, which at a minimum, requires a data model similar to the one encapsulated with the following high-level description:

a. Asset Node Container:

i. Asset Node Container ID, which is automatically generated by the system, by means of a recursive query that inspects the original digital assets for one or many parts, in the instance of an already formatted 3D object, this may include; individual vertex offsets; the UV mapping for each texture coordinate vertex; the faces that organise polygons into the object's list of vertices; texture vertices and vertex normals. In cases other than 3D Models, it is likely that the digital object will only have one ID, the model's self, since it is likely to be a single object. The administrator is also free to create more than one node against a single object, by marking the virtual location of these areas inside the single digital model as a form of hotspot by using the CLNDE.

ii. Vector data detailing each descendant object node translation (position), dilation (scale), and rotation, in relationship to the parent object, which by default is generated by the data model initialising query but can also be manipulated by the content manager through the CLNDE.

iii. Vector data, as encapsulated by the data structure Container Learning Phase Complexity External Media Linkage in FIG. 9, detailing each descendant object node translation, scale, and rotation of visible information labels or windows fixed in relationship to the parent object, which by default is generated by the data model initialising query but can also be manipulated by the content manager through the LPE.

b. Experience Trigger Setup, as detailed by the data structure Event Trigger Linkage and its dependencies; Event Trigger Type; Action Type; Learning Phase; and Complexity Level; depicted in FIG. 9, which can process any of the following:

iv. GPS data to locate an outdoor real object to which an AR experience is attached, when only rough area mapping is required.

v. SLAM data map to navigate indoor/outdoor real objects, as serialised by a SLAM scanning system after an initial area scan is concluded successfully.

vi. Image or Object Target to identify physical image/s or object/s that is used for tracking and augmentation purposes.

vii. An array of other possible triggers that act together to create a single experience trigger (for instance, GPS in tandem with Object Recognition to initialise an experience only at a specific location and only if a specific object is present in the location).

c. Learning Phase and Complexity Level:

The Learning Phase, and Complexity Level Data structure, depicted in FIG. 9, provides the configuration mechanism for laying out the base line on the function of the material being presented at each particular stage of learning, and expressing the expert opinion on the level of difficulty inherent in learning such material.

Since the primary object, after preliminary processing, is managed as a set of linked Asset Node Containers, the system makes the 3D object a queryable structure relating to its processed induced labelling, as well as positioning vectors.

The Asset Node Containers, depicted in FIG. 9, are used to associate further learning information as “add-ons” that are injected into specific locations on the surface of the primary object. These extended learning immersions are contingent on the trigger mechanism configured by the administrator, which relate to learning phase and complexity level specific conditions, as well as other environmental conditions which relate to how different augmented reality initiating events can be accessed by the application (for instance, image/object/site recognition) that add to the learning experience.

The system also encourages the administrator to learn better ways to present learning experiences, since:

i. The data framework, manipulated through the CLNDE, may begin as an empty set, guiding the content manager or administrator of the system to create new learning categories. However, an already existing data set will also have recorded the progress, and challenges, that students have endured in their last learning cycle. By examining reports that can be produced by the LMHA the administrator can: expand on helpful learning branches, remove cumbersome learning pathways, mark influential, but non-familial learning relationships, with other categories already assigned within the context of the learning experience.

ii. The data framework, manipulated through the CLNDE, defines influential, but non-familial learning relationships, as externally related to other categories by reference to common property/properties, or label/s, which act as natural links to external categories through the usage of a common property as an alias, highlighting a new learning insight that denotes that special case categories may be known or perceived also on how they impact on their non-familial categories. For instance, an Asset Node Container may be defined as part of a muscle group, with associations of other muscles that may not be physically connected but perform similar functions. This association may be critical to teach students to think in conceptually broader terms. Similarly, the Inferior Rectus muscle is the antagonist of the Superior Rectus muscle, meaning that it is produces the counter movement of the other muscle. Educators, by using the CLNDE, are free to mark non-familial learning relationships with any appropriate label that strengthen the learning model (for instance, within an anatomical, chemistry or engineering learning context the use of “associative” or “antagonistic” labels, declares a unique system as having the properties of being an “association” or an “antagonistic” partner of such declared categories, with the given properties having their own set of implications according to the context of the subject matter).

iii. Non-familial learning categories can either already exist, denoted by alternative aliases in the system, or be declared by the administrator as a new context to which educational material may be re-packaged.

The system further includes a visual drag and drop module that enables visual components of the system to accept commercially compliant digital media formats, by accessing third party optimization processes to act on non-compliant digital assets, thus transforming them into target or device optimized assets. In an example embodiment, the asset optimization is not automatically available for the specific instance, then it is also possible for the administrator to make manual modifications to the asset by using their own third-party tools to optimise or reformat the digital asset to meet commercial compliance. The optimized digital assets are treated as base objects to which sets of interactable digital assets are attached via the CLNDE. The content developer may accept or reject any of the system “actionable recommendations”, creating their own virtual location->labelling->information->interaction flow for any nodes internalized by the digital asset through the CLNDE module.

An on-line content management module procures the TCP/IP communication and data processing layer, securely transmitting and receiving pertinent data, through its default https protocol, to source the information and interactive paths of digital experiences that have been transformed by the system to VR or AR learning interactables through the CLNDE, such that they promote navigation through personalised learning paths embedding gamification elements, which also provide records on specific learning.

Video Streaming services are enabled and may be used to share live synchronous chatting to enhance exploration and learning.

AR and VR video sound-feed can be recorded to share with peers, extending the concept of student reflection as a form of re-iteration to gain improvement insights.

According to one aspect, the system comprising: an online content management module, inherently accessing the CASTMDM system, accessible by at least one administrator and/or user, but including various other roles as determined by its context, the administrator managing the selection and creation of digital material delivery channels, within the domain of the Course Channel Administrator Module, CCAM, including most modern forms of digital representations.

At least one apparatus having a client application coupled to be in communication with the on-line system via a communications network relying on the CASTMDM system application programming interface, API, and client app components of the present disclosure. The apparatus may be a mobile phone, a laptop, a smart phone, wearables, or any other smart interactive devices.

Computer readable program code components configured to enable the user accessing the client application to download one or more media items to a local storage system upon interrogation of a database residing in a content management module.

Preferably, the system issues a unique client token upon selection of a specific client app, which is used to authenticate all API calls by the content management module and ensure that only valid applications are accessing the system.

Preferably, the submission to create a new channel, through the CCAM module, elicits the creation of a new content management module channel and application programming interface application token, the channel and uniquely identifiable application token being required to isolate records from other client applications.

Preferably, upon authentication of the client application, the client application will download one or more content management module experience package/s that are either not present in a local storage system or have been modified by the content management module portal but not yet downloaded by the client application.

Suitably, at least one alert is issued to a user and/or administrator in the event that there is a connectivity disruption or downloading issue.

Preferably, at least one request and at least one response issued by the system is in JSON format, with a structure suited for its business, but also provisioned with a header object, denoting a field with a value declaring the main purpose of such JSON.

Further features and forms of the present disclosure will become apparent from the following detailed description.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings.

In order that the present disclosure may be readily understood and put into practical effect, reference will now be made to embodiments of the present disclosure with reference to the accompanying drawings, wherein like reference numbers refer to identical elements. The drawings are provided by way of example only, wherein:

FIG. 1 illustrates an authentication, activation and initial configuration of a client application from a Central Processor fitted with components of a system for consumption of a user, or student, thus representing a typical implementation of the client application according to an embodiment herein.

FIG. 2 illustrates how an authenticated user, through a client application module, triggers an AR/VR Educational Content according to an embodiment herein;

FIG. 3 illustrates how an authenticated administrator or a content manager accesses a content management module (CMM) to which a central processing unit coordinates other modules in appropriate fashion to provide one or more functionalities according to an embodiment herein;

FIG. 4 illustrates a Central Learning Nodes Design Editor when an administrator or a content manager loads primary and supporting Digital Media according to an embodiment herein;

FIG. 5 illustrates the Central Learning Nodes Design Editor when the administrator or the content manager configures an educational skin according to an embodiment herein;

FIG. 6 illustrates an authenticated administrator or the content manager accessing the Learning Phase Editor to Configure Educational Phases according to an embodiment herein;

FIG. 7 illustrates a question and answers module admin interface available to an authenticated administrator or the content manager according to an embodiment herein;

FIG. 8 illustrates utilisation of a Digital Assets Query Module by an authenticated administrator or the content manager according to an embodiment herein;

FIG. 9 illustrates a Core Data Model for Asset Catalogue that shows a data model and respective data relationships for conducting the core serialisation and set of queries pertinent according to an embodiment herein.

FIG. 10 illustrates a Learning Monitoring and Habit Assessment Application (LMHA) Components and respective interactions of different software layers within an application enabled by CASTMDM components system according to an embodiment herein;

FIG. 11 illustrates a Questions and Answers Data Model (QADM) according to an embodiment herein;

FIG. 12 illustrates a Learning Monitoring and Habit Assessment (LMHA) Data Model according to an embodiment herein;

FIG. 13 illustrates a Topic Wizard Data Model that shows a record structure, data fields and external relationships with other core data models according to an embodiment herein;

FIG. 14 illustrates an Educational Skin Data Model (ESDM) according to an embodiment herein; and

FIG. 15 is a flow diagram illustrating a method of transforming 3D models or animations into 3D educational objects for providing educational experiences addressing personalised learning paths of students/trainees.

Skilled addressees will appreciate that elements in the drawings are illustrated for simplicity and clarity and have not necessarily been drawn to precision. For example, the relative relation of some of the elements in the drawings may be simplified to help improve understanding of embodiments; or in other instances the possibility of system calls or procedure failures are not illustrated to present the sequence of events or system tasks that would log exceptions; present warning dialogs to the user; or show the system gracefully terminating after a failure, although it may be safely assumed that such cases would be catered for in any implementation or version of the present disclosure.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

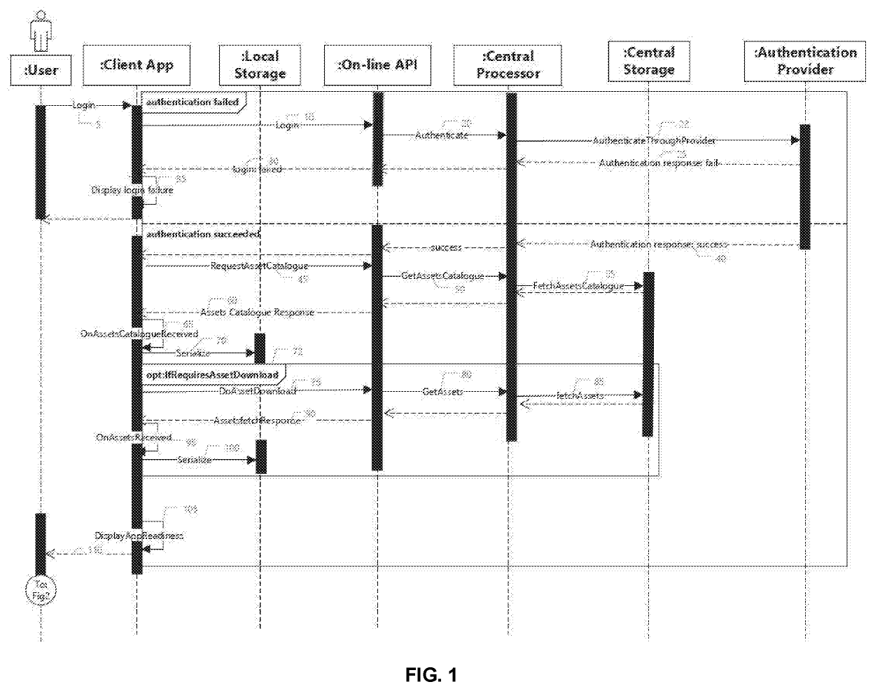

FIG. 1 illustrates an authentication, activation and initial configuration of a client application from a Central Processor or a content management module, fitted with components of a central system for consumption of a user, or student, thus representing a typical implementation of the client application according to an embodiment herein. The interaction of various components residing in the client application, as well as in the central processing unit, utilise an https secured connection to achieve activation through central validation of credentials and activation of critical on-line responses and services to resolve the initial configuration and activation of the client application. Upon activation, a user logs-in to the client application to which the application engages the central processing on-line API through the various client application components provision for such purpose. The user accessing the central processor, which engages an authentication algorithm to authenticate the credentials of the user against credentials managed by any variety of Authentication Provider layer options to validate or reject the access claim from the user depending on the validity of such credentials. Once the authentication succeeding, the central system responds with an asset catalogue provisioning the necessary download and configuration instructions to initiate the setup of the learning models in the client application. If the authentication fails, the client application provides an appropriate access failure message to the user.

In one embodiment, users are students or trainees. The user attempts to log in to a content management module 5 by logging their credentials through the client application 10, which through the API layer transmits an authentication request to the Central Processor or the content management module 20. The user credentials are authenticated through provider request to the assigned Authentication Service 22. If the content management module fails to authenticate a request 25, a login failure message is passed back to the client application 30. The user login failure is displayed to the user through a warning dialog 35. If the authentication request succeeds 40, the client application, requests the Asset Catalogue 45 from an online API, which is a configuration manifest describing the assets that require download and the default behaviour of each asset as prescribed by their learning phase and learning complexity context and their subscribed use either as AR or VR presentations. The Asset Catalogue is coupled to a Content Management tenant, or faculty, and a specific channel or course that have been set up for such purpose. The Gets Assets Catalogue API calls a tenant/channel identifier 50. The Central Processor layer creates the appropriate query using the call Fetch Assets Catalogue 55 that targets the database system staged by the Central Storage system, which responds with an empty Asset Catalogue, in cases of any failure, or with an appropriately constructed Asset Catalogue 60. The client application call back procedure on Assets received from the central processor 65 will serialize the Assets Catalogue in local storage 70, whether the manifest is empty or contains the appropriate configuration. The app will provide the appropriate failure message to the user in cases that the Asset Catalogue is empty at step 105. If the Asset Catalogue contains items that require download from the content management module, IfRequiresAssetDownload 72, then the DoAssetCatalogue function 75 in turn deploys the Get Assets API call 80. The Central Processor prepares a FetchAssets Query 85 which asynchronously retrieves the require digital assets from Central Storage as binary files that are transmitted through the network to the client application through the Assets Fetch Response 90 and once the call back on Assets Received 95 has a success response of the asset call back, the client application serializes the files in local storage 100. Once all downloads are completed or no downloads are necessary to the client application functions, the display app readiness displays a message to the user that all expected downloads have been completed, no downloads were necessary as the digital resources had already been downloaded or a failure has occurred 105. The user then responds to the client application in whatever fashion is appropriate, that is, continue or exit the app session respectively.

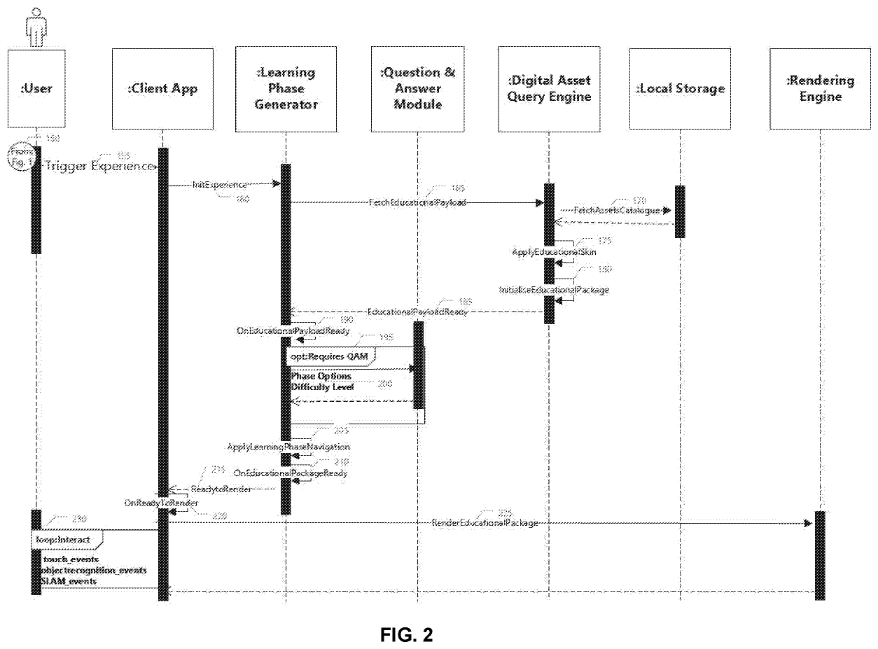

FIG. 2 illustrates how an authenticated user, through a client application module, triggers an AR/VR Educational Content according to an embodiment herein. The client application is made up of CASTMDM components that include a Learning Phase Generator (LPG), a question and answers module (QAM), a Digital Assets Query Engine (DAQE) to which various processes culminate in storing, or are required to construct an access from such storage during various phases of the client application lifecycle to instigate the rendering engine to produce the expected presentations and interactions. Once the user has been previously authenticated 150, the user triggers an educational experience 155 in a form prescribed by the configuration of the client application through the Asset Catalogue configuration properties. The client application, through InitExperience 160, instructs the local Learning Phase Generator to prepare a query to fetch educational payload 165. The query is passed through the DAQE to execute fetch asset catalogue 170. The DAQE waits for fetch asset catalogue to complete to apply educational skin 175 to the primary model that was fetched. The educational skin represents the virtual wrapping of a 3D object with a mesh of local points (e.g. regions) anywhere in proximity or contact with the 3D object, to which events will occur such as, virtual touching. The virtual touching represents touching an AR/VR projection at a specific point (whether through screen touch; articulated hand or eye tracking input retrieved through cameras; or pointer devices) or user input (through forms or other mechanisms) produce the reaction. The DAQE initialise educational package function 180, which prepares a preliminary extract for the later construction of the asset catalogue, which in this instance singly contains the vectors, which lists the properties of the educational skin. The education payload ready notification 185 is captured by the Learning Phase Generator through call back on educational payload 190. The Learning Phase Generator examines whether the current activation phase requires the configuration of a questions and answers module (QAM) 195. Examining of configuration of a questions and answers module (QAM) is reference to the client application session parameters. The phase options and difficulty level 200, evincing under which phase and complexity context the current session is being conducted. In one embodiment, the discovery phase does not contain the QAM, and as such, the configuration parameters controls are given to the administrator to fathom as configuration options. The system configures the learning phase navigation pathways in apply learning phase navigation 205, which pre-determines critical rendering pathways that prioritise the viewing of specific objects over others to increase clarity, hence, the discovery of specific objects may be pre-configured by the administrator to obey specific learning strategies. The function on educational package ready 210 determines when all asynchronous preparatory operations and functions have completed to finally respond with a ready to render notification after the complete protocol of behaviours have been configured within the asset catalogue object 215. The ready to render call back 220 engages an event loop 230, sensitive to touch, object recognition and SLAM events, acting on the system to trigger the behaviour protocols configured by the implementation of the asset catalogue instructions to render education package 225 from instant to instant, and event to event, until the user exits the client application through a unique event configured by the administrator to signify an exit request.

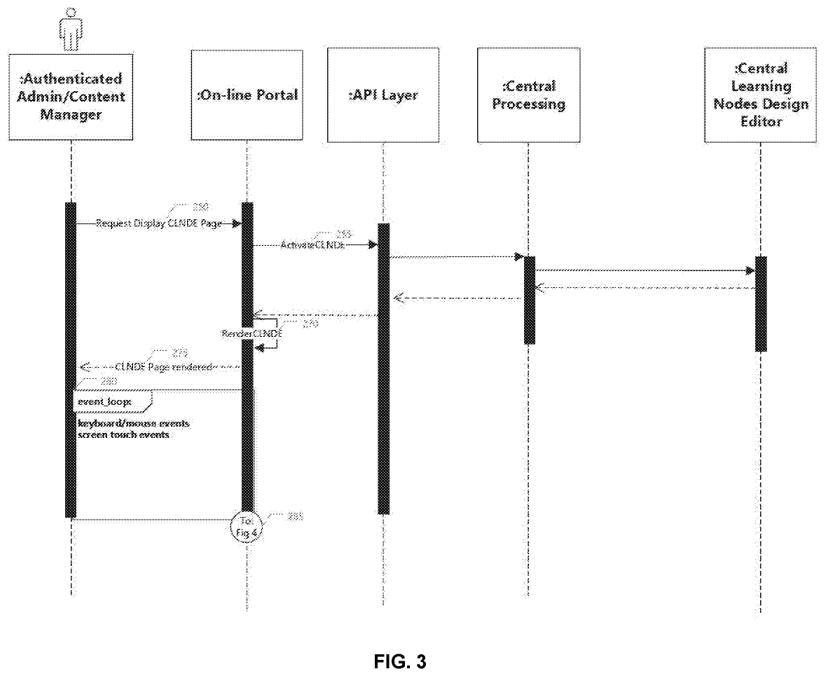

FIG. 3, illustrates how an authenticated administrator or a content manager accesses a content management module (CMM) to which a central processing unit coordinates other modules in appropriate fashion to provide one or more functionalities according to an embodiment herein. In one embodiment, the one or more functionalities include (a) store and distribute the client application configurations and digital content, (b) create new tenancies and channels, and (c) manage different roles, which includes the administrator/content manager, reviewer or report consumer, the user or student. The CMM is constructed within the scope of a multitenant architecture to which each potential tenant shares an instance of the hardware and software components, but has discreet domain over; their data, configuration, user management and individual configuration aspects of each tenancy. The tenancy configuration is also provided with the ability to create and configure channels, the maximum number of such channels limited by the set parameters of the instance's hardware/software limitations, which provide sub-divisions of the system. The match of faculty/course and user/student is provisioned by the tenancy configurations related to management of course profile and user, or student profile, junction management.

At step 250, the administrator or the content manager requests the online portal to display the CLNDE page. At step 255, the online portal activates the CLNDE at the API layer. At step 270, the online portal call back the render CLNDE. At step 275, the online portal displays the rendered CLNDE page to the administrator or the content manager. At step 280, the event loop is called, which includes keyboard/mouse events or screen touch events.

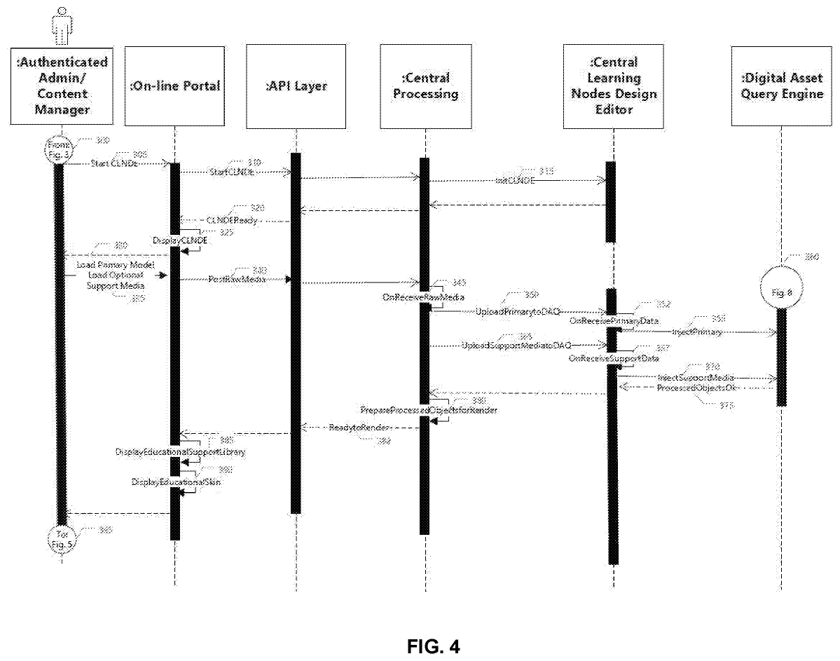

FIG. 4 illustrates a central learning nodes design editor when the administrator or the content manager loads primary and supporting digital media according to an embodiment herein. The on-line portal is engaged to enact a visual wizard to upload primary and secondary media. In one embodiment, the primary media is the object of educational focus, whilst the secondary media is the support material that is used to strengthen the learning experience. The on-line portal requests pertinent services via the API layer that in this instance require the central processing unit to execute the initialisation of the central learning nodes Design editor, to which the DAQE included to process the uploaded objects within their respective influence domain (primary or secondary).

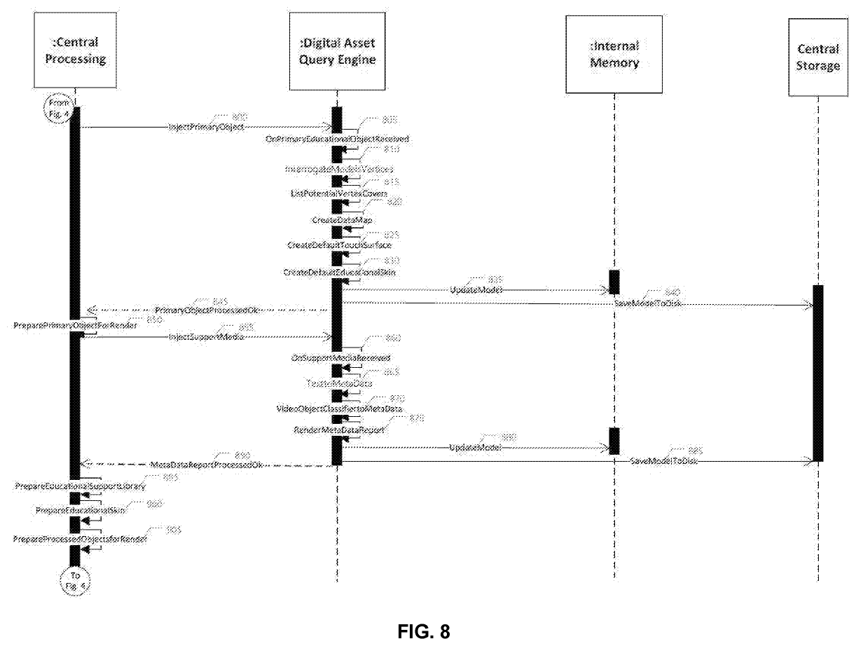

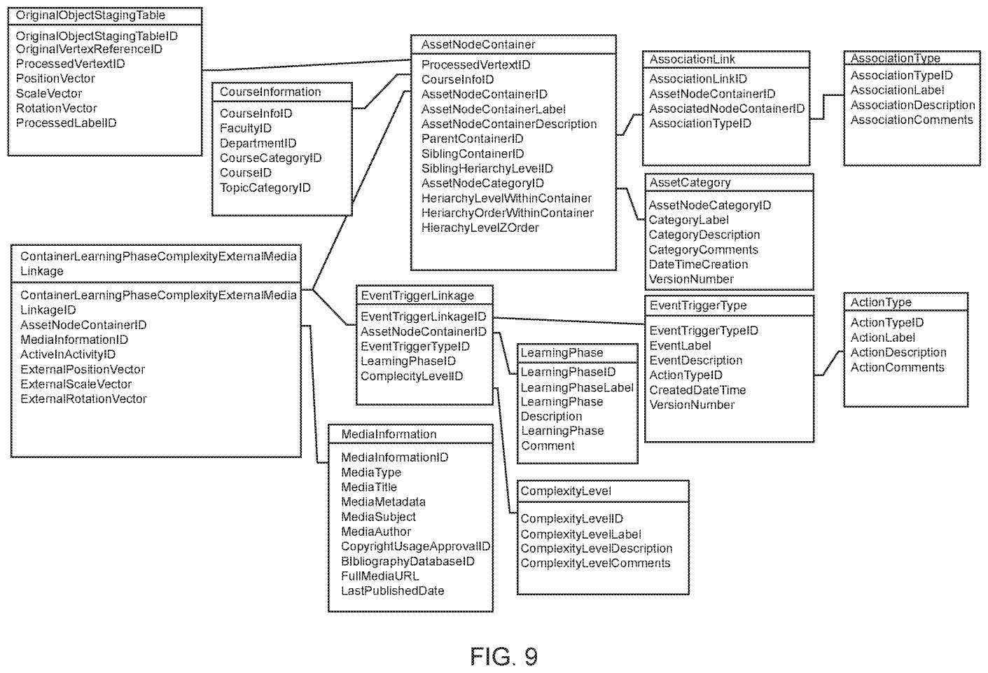

The authenticated administrator or content manager 300 selects the CLNDE through the on-line portal 305, which fires the start CLNDE command 310 through the API layer, causing the Central processor to execute init CLNDE 315, which initialises the CLNDE. The CLNDE ready notification 320 is received by the on-line portal layer using display CLNDE 325. The online portal projects the wizard for the administrator's consumption 330. The administrator loads the primary model and support media, if required 335. The post raw media call 340 induces central processing to process the posts via the on receive raw media call back 345, which when complete uploads the primary object through the UPLOAD PRIMARY TO DAQE call 350. The CLNDE processes this payload via the OnReceivePrimaryData 352 which turns the object stream into a text (e.g. .OBJ format), if the data is not already in that format. This primary object, in an .OBJ format, is sent to the DAQE Engine for further processing via the Inj ectPrimary call 355. The rest of the support of material, if any, is also routed to the CLNDE via UploadSupportMediatoDAQE 365, to which its payload is processed by OnRecieveSupportData 357, which optimises the original support components (for instance, video/audio/static pictures/text/other 3D objects) into more efficient data streams for the consumption of mobile devices, prior to packaging and using the InjectSupportMedia 370 which routes the reworked support data into the DAQE Engine for final processing 360. Once the DAQE Engine has completed the tasks related to this process, it responds with the event ProcesseObjectsOk 375 to the Central Learning Nodes Design Editor, indicating that the data model and relations illustrated in FIG. 9 have been serialised into internal memory, as per interactions described in FIG. 8. The Central Processing catches the ProcessedObjectOk event in PrepareProcessedObjectstoRender 380, which acts primarily as a semaphore to achieve synchronisation of the various processes that require resolution prior to any attempt at rendering. The On-line portal layer waits for the ReadyToRender event 382 to be captured by the DisplayEducationalSupportLibrary 385, which displays the appropriate support elements that were initially injected as support media and are now available as digital components that can be injected into the newly created Educational Skin. The DiplayEducationalSkin 390 completes and displays the Primary Object, now with an Educational Skin ready to be assigned the workflow intended by the administrator 395.

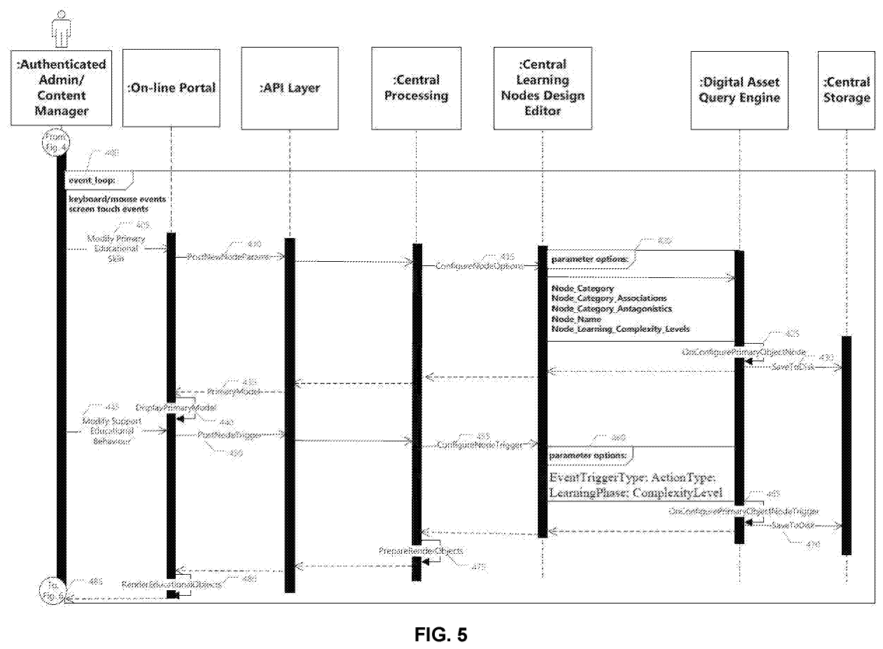

FIG. 5 illustrates the Central Learning Nodes Design Editor when the administrator, or the content manager is tasked to configure the Educational Skin according to an embodiment herein. In accessing the system, an on-line portal is engaged, which fires requests, via the API layer, instructing the central processing unit to initialise the Central Learning Nodes Design Editor which is supported by the DAQE to process the originally injected object, to which an educational skin will be applied, along with any supporting material which is turned into an educational support library by the system.

The Authenticated Admin/Content Manager is already working with the on-line Portal tools and the system is tracking all user events through an event loop 400. The administrator elects to modify the Educational Skin by reference to the appropriate selection presented by the on-line portal 405, to which the on-line portal fires PostNewNodeParams 410, which prompts Central Processing to execute ConfigureNodeOptions 415, aligning the Central Learning Nodes Design Editor to present Node_Category; Node_Category_Association; Node_Category_Antagonistics; Node_Name; and Node_Learning_Complexity_Levels as configuration options 420. The DAQE Engine prepares the educational skin data model and its counterpart the interactive components of the Educational skin OnConfigurePrimaryObjectNode 425 to provision the system with read and write permissions that will modify the skin data model, including the trigger configuration. A copy of the current primary skin data model and its event trigger configuration is saved to disk by SaveToDisk 430. The On-line portal receives the JSON package identified by an internal header notification with the text value PrimaryModel 435 through the DisplayPrimaryModel callback 440. When the Educational skin is enabled, the administrator can begin to modify or integrate further digital material 445. Simultaneously, as new digital material is injected as an add-on to the educational skin, the trigger mechanism of the AssetNodeContainer can also be modified and the changes are communicated up the system hierarchy by PostNodeTrigger 450, fired by the on-line portal layer, which induces central processing to execute ConfigureNodeTrigger 455, which attentive to its parameters 460, can assign any of the trigger configuration options described by Experience Trigger Setup in section 034b. The call-back OnConfigurePrimaryObj ectNodeTrigger 465 causes a save of the modifications of the object by executing SaveToDisk 470, immediately after which Central processing is induced to PrepareRenderObjects 475, ensuring that the primary and support media modification processes have been synchronised before finally causing the on-line portal to RenderEducationalObjects 480. After all the Education Skin modifications are completed the administrator may elect to begin work with the Learning Phase Editor to configure educational phases 485.

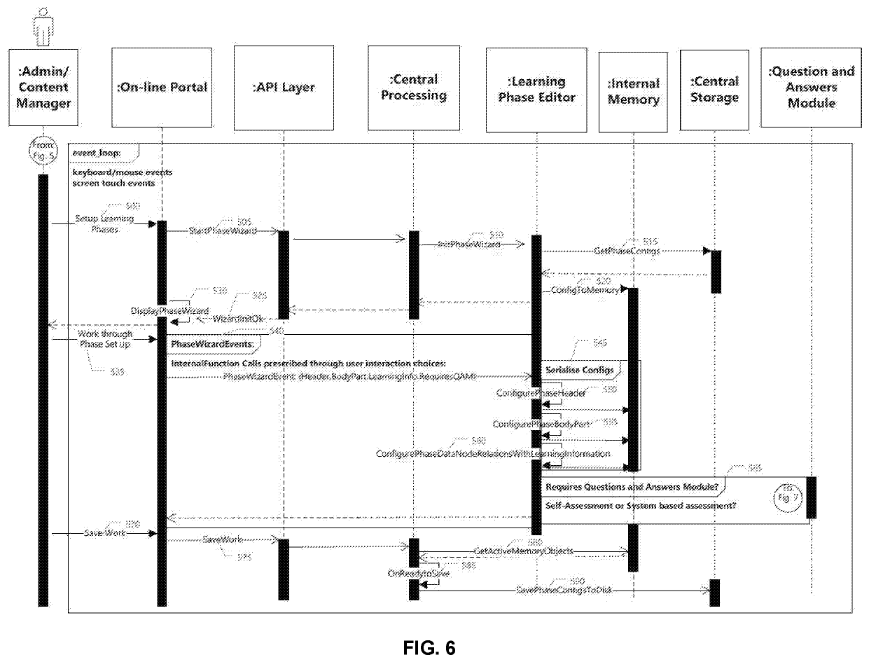

FIG. 6 illustrates an authenticated administrator or the content manager, accessing the Learning Phase Editor to Configure Educational Phases according to an embodiment herein. In accessing the system, an On-line Portal is engaged to enact a visual wizard that sets up the learning phases required, which includes a discovery, learning and evaluation phase to which the on-line portal requests pertinent services via the API layer, that in this instance instructs the Central Processing unit to initialise the Learning Phase Editor and sequencing the Question and Answers Module to also engage internal memory processes and central storage facilities.

The Authenticated Admin/Content Manager is at a stage ready to set up the Learning Phases 500. The administrator selects the option to StartPhaseWizard, fired by the display in the on-line portal 505, which causes central processing to InitPhaseWizard 510, that is, initialise the Phase Wizard, which loads default configurations to set up the initial phases that the administrator can utilise to begin their build by calling on GetPhaseConfigs 515 from the Learning Phase Editor. Immediately after the default phase configuration is loaded from Central Storage it is also copied to internal memory for later use 520. A JSON, with an internal header notification with the text value WizardlnitOk 525, is sent back as positive response, which is processed by the on-line portal function DisplayPhaseWizard 530. The administrator works through the Phase Wizard options 535, and the wizard in turn responds to the administrator input through an event processing poll 540. As the administrator works through the configuration options available, they are presented with a series of activities which include ConfigurePhaseHeader 550; ConfigurePhaseBodyPart 555; and ConfigurePhaseDatallodeRelationsWithLearninglnformation 560 (a figurative term for the sake of clarity, rather than its proper functional name).

The ConfigurePhaseHeader 550, relies on a template generator, which defaults to prompting the administrator to create new/or accept the default HeaderTitle, which denotes the learning phase title. The system includes suggested HeaderTitles as Discovery (AKA Exploration), Learning, and Assessment Phases, although the administrator is free to create new learning phase labels. The system prompts the administrator to provide a “Description” and “Summary of Objectives” for that specific phase. This is important to remind the administrator that each phase created is a container of properties and triggers that may be executed within the domain of that phase.

During the ConfigurePhaseBodyPart stage 555, the administrator is prompted by the system to review the unedited “educational skin”, represented by the virtual wrapping of a 3D object with a mesh of local points anywhere in proximity or contact with the 3D object supplied as the primary object of focus. The LPE provides a visual editor with a 3D projection system that permits the administrator to peruse the objects displayed in the editor poised through the full range of viewing angles and scales. The unedited “educational skin”, wrapped around the primary object as initially generated by the DAQE, provides the means to focus on any point of interest, on any part of the Primary 3D object/animation, which the administrator interacts with to substitute such points of interest with interactive anchors. These interactive anchors are the locus to which other visual objects, interactive elements, or even sound schemas, simulate their tethering to inject contextual valid educational elements. This network of interactive anchors also injects event notifiers for any number of user or system events (touch or mouse event, keyboard input, eye gazing or visually recognised gesture tracking, point location mapping or entering or leaving a configured proximity fence and such like).

During the Configure Phase Data Node Relations With Learning Information stage 560, the LPE provides the ability to “mark” any point in the “educational skin” with a score range set up by the administrator, from the lowest score signifying nil focus requirements to the maximum indicating crucial focus priority, in reference to one or any of the Learning Phases already configured. This action sets up the “level of focus relevance by phase and item”, e.g. LFRPHI scoring. The LFRPHI scoring offers a prioritisation referencing prompt that administrators rely on to later adjust the learning phases, types, frequency, and learning activities placed on such markers to increase the value of the learning experience once progress outcomes have been captured and analysed. Under the LFRPHI schema every point in the “educational skin” has varying degrees of focus priority, requiring different levels of educational planning and implementation from one phase to another, as each level of focus precedence may be lowered or heightened depending on the objectives and requirements of that learning phase. An ML hybrid (MLH) recommender system employs a multi-stage approach to select reference metadata as the system iterates through the educational documentation accessible to the system, automatically extracting document specific implicit and explicit metadata, such as, topic name (which for the purpose of this system is also known as the AssetNodeContainerLabel in the AssetNodeContainer structure) and subject information, and other identifying characteristics. The MLH also carries out a cross reference analysis using a theme relevance scoring system to cluster documents with common elements together. This information is used by the administrator to perform intelligent searches on topics that will bring in more focussed and detailed information into the subjects sought, especially as LFRPHI scoring is applied, to assist the system to sort and match through results bounded by the immediate context of the learning phase which imparts relevance to the interactive anchors that implicitly enforce it as the centre piece for that phase.

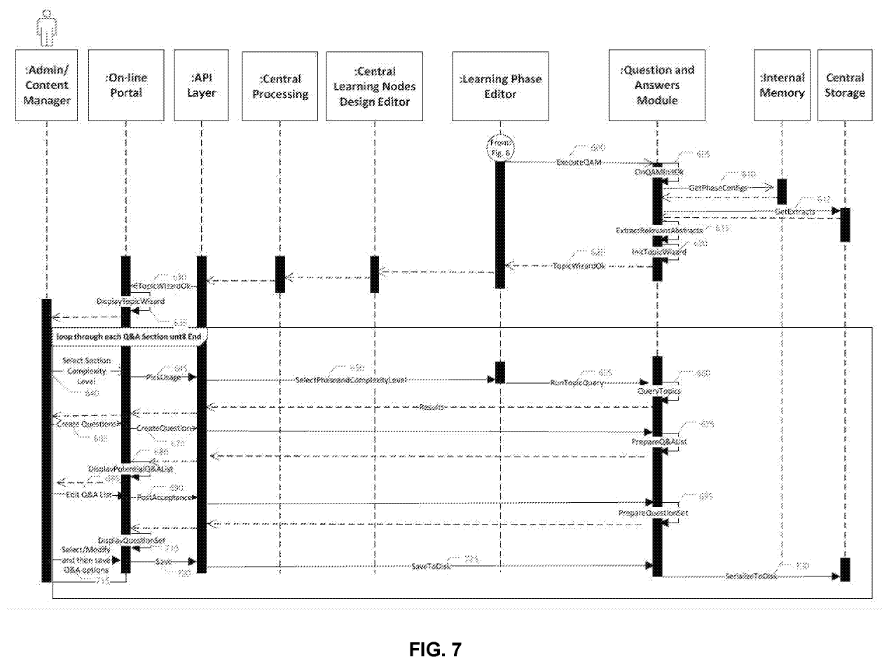

The system requires QAM support, 565, the system provides such abilities, in reference to a detailed description of critical interactions illustrated by FIG. 7 which expounds how the QAM is administered. Once the administrator completes all tasks prompted by the Learning Phase Editor, the administrator typically proceeds to save their work 570, using the portal layer function SaveWork 575, which induces central processing to GetActiveMemoryObjects 580, and prepares such in the call OnReadyToSave 585, which when ready executes SavePhaseConfigstoDisk 590.

FIG. 7 illustrates a question and answers module (QAM) admin interface available to an authenticated administrator or the content manager according to an embodiment herein. In accessing the system, an On-line Portal is engaged to enact a visual wizard to set up the Questions and Answers delivery system. The on-line portal requests pertinent services via the API layer that in this instance instructs the Central Processing unit to initialise the Question and Answers Module, the Central Learning Nodes Design Editor, the Learning Phase editor to which internal memory processes and central storage facilities may also be used in support of injecting questions and answers into the system.

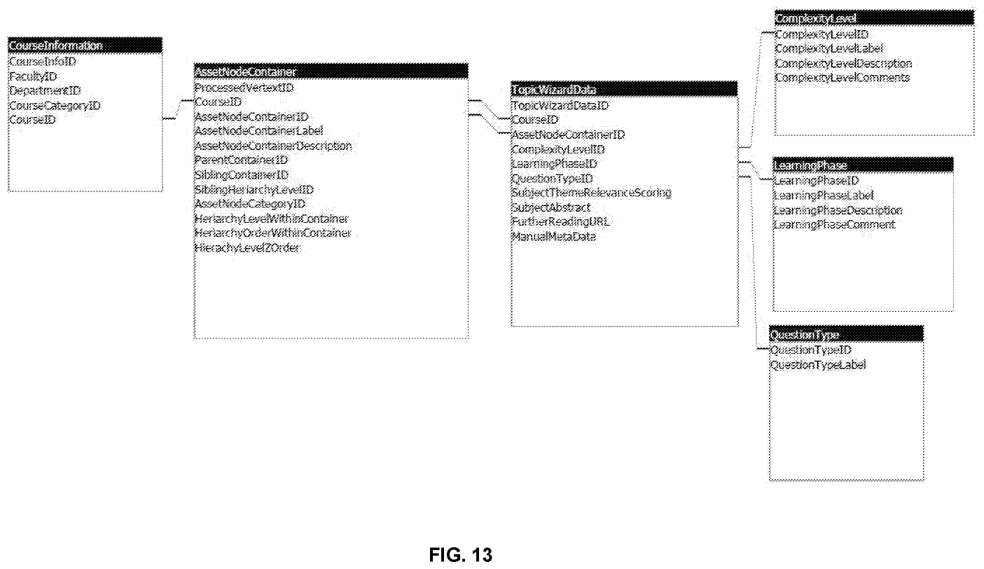

Whenever the QAM is engaged, following subsequent actions detailed in FIG. 6, ExecuteQAM is launched by the LPE 600. The QAM responds through OnQAMinitOK 605, which initialises the QAM and fires the GetPhaseConfigs 610 to access the ContainerLearningPhaseComplexityExternalMediaLinkage data model and its dependencies; with an illustration of such data relationships displayed in FIG. 9. Get Extracts 612 is the next call from the QAM which gets the entirety of the digital reading material meta data from central storage that may relate to the topics discussed by the different phases of learning. This material is processed by ExtractRelevantAbstracts 615, which utilises a hybrid recommender system to filter through the most appropriate material for the requirements of the course, since ExtractRelevantAbstracts permits the administrator to configure the metadata input that would most likely obtain the best material for use, along with the system utilising the labels already serialised by the AssetNodeContainer hierarchy as asserted meta data instructions. The InitTopicWizard 620 QAM process translates the resulting digital reading material into queryable objects (JSON nested arrays) for dynamic consumption. The on-line portal layer waits for the JSON object identified by an internal header notification with the text value TopicWizardOk 630, which carries the appropriate payload, as detailed by FIG. 13, to instruct DisplayTopicWizard 635 to paint and activate the Topic Wizard. The Topic Wizard conducts searches for extant material that may be of relevance given a specific phase, complexity level or AssetNodeContainer context (that is, its AssetNodeContainerLabel and other supporting fields). Such search results can be viewed as recommendations that assist administrators in the design of questions and answers.

During the question creation stage in FIG. 7, commenced by the administrator by selecting the complexity level instructing the session 640, the Topic Wizard provides a sub-component, PickUsage 645, which permits the joining of Phase and complexity levels utilising the function SelectPhaseandComplexityLevel 650, which elicits the LPE to RunTopicQuery 655. The QAM responds in kind by executing QueryTopics 660, which actively engages the Topic Wizard to run specific queries on its already processed data to provide a breakdown of any material that corresponds with the learning phase, complexity level and, if so desired, specific AssetNodeContainerLabels or synonyms of such, which for the purpose of the system act as topics of interest. The results are listed in pertinence order, from highest to lowest score, by SubjectThemeRelevanceScoring (as part of TopicWizardData, FIG. 13). The administrator creates questions 655, relying on the support provided by the Topic Wizard recommendations.

The CreateQuestion 670 function is submitted through the on-line portal, which is processed by the QAM in PrepareQ&AList 675. The context and functionality of PrepareQ&AList output generates different types of assessments, which automatically produce assessment instances for the different contexts (i.e. learning phase and complexity level required). This list or Q&A instance recommendations is packaged and displayed to the administrator by

DisplayPotentialQ&AList 680. The administrator proceeds by accepting, editing, rejecting, or reformatting parts of the assessment instance for the Question and Answer set provided by the system 685. The edited listing is posted back by the administrator through the on-line portal PostAcceptance function 690. The re-edited list is once again processed by the QAM in PrepareQuestionSet 695, which returns back the appropriate instance type set up and the question and answer set pertinent to that type of assessment. The revised question set is displayed by the function DisplayQuestionSet 710, which displays the set in both student and administrator view options. Finally, the administrator approves and saves the assessment instance 715 by opting for Save 720, which executes a SaveToDisk instruction 725, causing the QAM to serialise the assessment instance into Disk, SerializeToDisk 730.

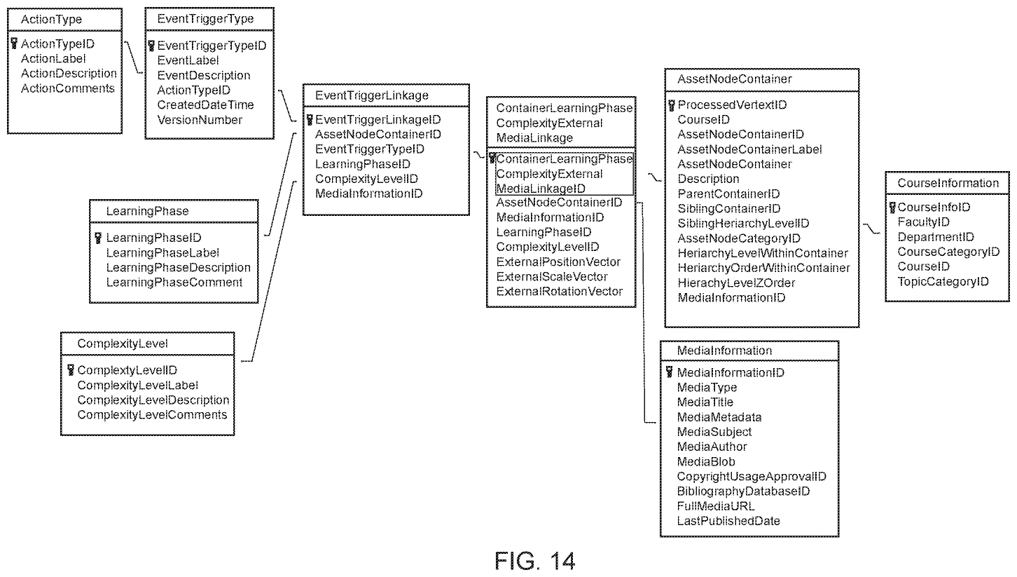

FIG. 8 and FIG. 14 represent the system interactions and data processing requirements of a typical Educational skin implementation. The Educational Skin contains both an event sink and response activities that can be configured by the administrator. In terms of the event sink, the schema depicted in FIG. 14, EventTriggerType, defines a number of events that instantiate the responses listed by ActionType. The defined sink event causes a response which spawns the activity linked through the various relationships in the schema as depicted in FIG. 14. There are various data concerns and relationships that the system resolves, critically supported by ContainerLearningPhaseComplexityExternalMediaLinkage which acts as the coordinating junction.

An EventTriggerType can be any of the following: GPS, signifying that specific GPS locations, or on the device detecting proximity to such location, such that the linked activity will be rendered or activated; Image Recognition, signifying that whenever the system identifyes a specific image the linked activity will be rendered or activated; Object Recognition signifying that whenever the system classifies an object of a specific class the linked activity will be rendered or activated; Bluetooth Fencing, signifying that whenever the system detects specific Bluetooth identifiers the linked activity will be rendered or activated; Site Recognition, with simultaneous localization and mapping (SLAM), signifying that whenever the system detects a specific site through image/or object recognition, the linked activity will be rendered or activated following SLAM principles.

An ActionType can be any of the following: Render Raw Node, signifying that the only the primary object should be visible; Render Node with Extra Media, signifying that the connected but external media object should also be presented; Remain Invisible, signifying that the primary object should be made invisible; Render Sound Only, signifying that the primary object should be made invisible but the linked sound file should be played; Use Transparency Rules, signifying that either the primary or secondary object should be made transparent by a certain percentage as configured.

FIG. 8 illustrates utilisation of a Digital Assets Query Engine (DAQE) by an authenticated administrator or the content manager according to an embodiment herein. In accessing the system, an On-line Portal is engaged to enact a visual wizard to set up the DAQE. The on-line portal requests pertinent services via the API layer, that in this instance instructs the central processing unit to initialise the Digital Assets Query Module to which internal memory processes and central storage facilities are also engaged in support of discovering and serialising the various schemas required to generate the primary object with its extended Educational Skin and the secondary object or objects as supportive junctions for said educational skin.

The authenticated administrator uploads the primary model, which causes central processing to post the data through InjectPrimaryObject 800 to the DAQE. This primary object is the form of an OBJ text file. After the data transfer to the DAQE has occurred without error OnPrimaryEducationalObjectReceived 805, the DAQE uses InterrogateModelsVertices 815, which recurses through every vertex offsets, the UV mapping for each texture coordinate vertex, the faces that organise polygons into the object's list of vertices, texture vertices and vertex normals to generate a mapping of the object to support the ultimate creation of the Educational Skin. ListPotentialVertexCovers 815 identifies every point in this map that may be used by the system as a vertex cover, or node cover, in which a set of vertices is such that each edge of the graph is incident to at least one vertex of the set. By using a NP-hard optimisation technique, with an approximation algorithm, the system resolves the maximum amount of vertex covers used by the system as Educational Skin. CreateDataMap 820 transforms the vertex covers into a location mesh that can be wrapped around the primary 3D object. The CreateDefaultTouchSurface data model 825 provides the means to configure how the user or student will interact with the different regions of the Education Skin, in terms of TriggerEventType events. The Educational Skin is completed by the function CreateDefaultEducationalSkin 830, which adds ActionType to resolve the activities that will respond to the already configured events and packages the JSON object identified by an internal header notification with the text value PrimaryObjectsProcessedOK 845. The UpdateModel 835 function finally integrates the initial 3D model with its new Educational Skin. This co-joint model is saved by SaveModelToDisk 840. The JSON object is posted back to central processing 845, where the function PreparePrimaryObjectForRender 850 hooks up the configuration to the rendering system.

FIG. 8 further involves in uploading secondary support media and that is performed by InjectSupportMedia 855, which transfers the necessary data to the DAQE for OnSupportMediaReceived 860 to initiate processing upload processing. The proceeding call TextToMetaData 865 is a Natural Language Processing (NLP) filter that automatically produces metadata for the documents it processes. The sequence of procedures within this function relate to conversion of the text to lower case; the removal of common stop words, punctuation, blank spaces and meaning neutral tokens; text stemming; the creation of a document matrix containing the frequency words within the document; performing association analysis across frequent terms found in separate sentences; and reducing the most relevant words to a metadata list. The VideoObjectClassifiertoMetaData 870 function performs live object classification, on such video footage that has been recorded in an acceptable file formats, for the purposes of adding them into the presentation as secondary virtual skin objects including the processing of text classifiers that are logged for further processing. Once the video has completed its run, the classifications logged are taken though a similar NLP filter, as already discussed, to produce metadata that can provide textual context for video material. This meta data extraction processed is completed by RenderMetaDataReport 875, which matches the support media provided to the meta data produced for more efficient identification and consumption. This information is loaded to internal memory through the UpdateModel 880 function, and also saved by SaveModelToDisk 885. A JSON object identified by an internal header notification with the text value MetaDataReportProcessedOk 890 is dispatched by the DAQE, which is further processed by PrepareEducationalSupportLibrary 895 to supply the rendering engine with the appropriate visual/audio elements that were initially injected as support media and that are now available as digital components ready to be injected into the Educational Skin. PrepareEducationalSkin 900 and PrepareProcessedObjectsForRender 905 complete the rendering preparation cycle by supplying the rendering engine with the necessary constructs to complete the rendering cycle on all visual objects.

FIG. 9 illustrates a Core Data Model for Asset Catalogue that shows a data model and respective data relationships for conducting the core serialisation and set of queries pertinent according to an embodiment herein. This representation is by no means the absolute or ideal implementation, but rather a representation of a viable solution without recourse to more detailed specifications that will not further the claims here in.

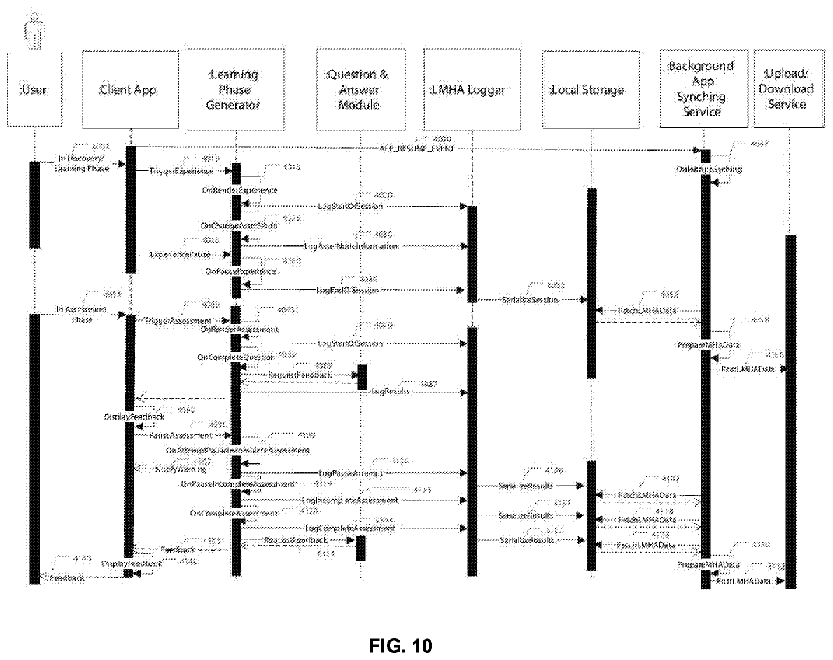

FIG. 10 illustrates a Learning Monitoring and Habit Assessment Application (LMHA) Components and respective interactions of different software layers within an application enabled by CASTMDM components system according to an embodiment herein. In this instance the user or circumstances (i.e. a scheduled assessment event), cause navigation through the different learning phases. Once the client application triggers the experience, that is initialises the experience as a response to the trigger events configured, the Learning Phase Generator traps a series of events from rendering the initial experience to the completion of an assessment, depending on the learning phase encountered. At each terminating event the LMHA Logger serialises the session, results, or more likely both sequence of events into local storage. A delta synchronisation is performed by an application service, which determines what needs to be uploaded to the server, and performs said tasks as a background operation of the app.

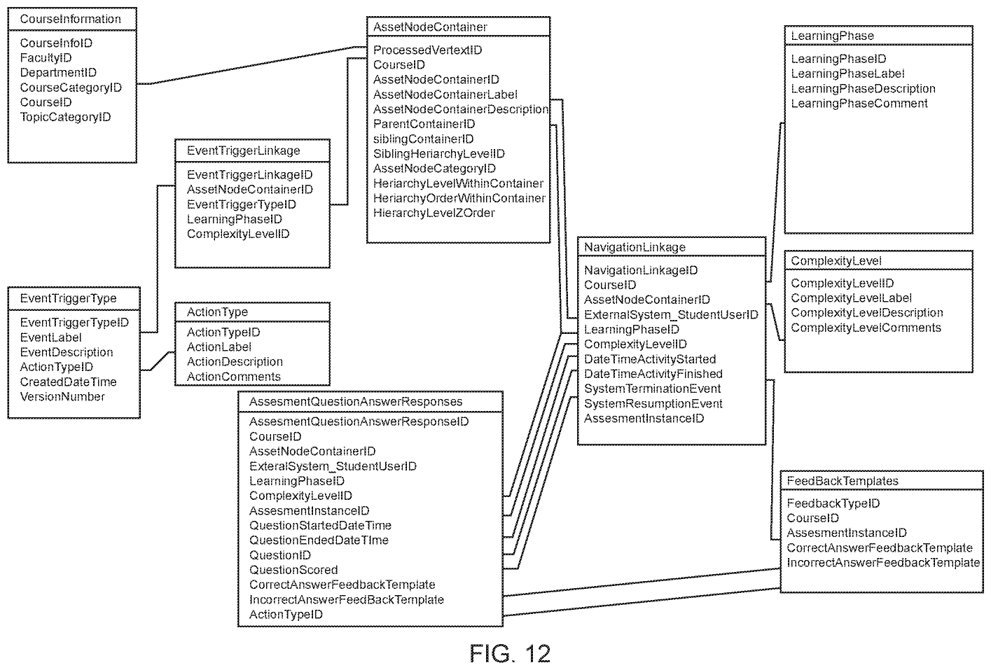

The instance the application is started or reawakened an APP RESUME EVENT is fired 4000, and a background thread or service initialises to accommodate the LMHA by executing OnlnitAppSynching 4007. Meanwhile, the user elects to navigate either the discovery or learning phase 4008 by appropriately interacting with their device. Whenever an experience is triggered by the client application in response to its trigger configuration, the TriggerExperience call 4010 is launched. This causes OnRenderExperience 4015 to render or activate the configured experience and execute LogStartOfSession 4020, which begins a new logging session for the LMHA logger. OnChangeAssetNode 4025, acting on any input by the user that causes focus on a new AssetNodeContainer, or vertex cover, executes a LogAssetNodelnformation 4030 with all the pertinent information required to formulate a log record, which has at least information relating to FIG. 12, NavigationLinkage record. similarly, an ExperiencePause 4035 request caught by the LPG OnPauseExperience 4040 call back causes LogEndOfSession 4045 serialised by the NavigationalLinkage record.

The session is saved to LocalStorage by SerializeSession 4050, which permits the background app synching service, BASS, to FetchLMHAData 4052 at the most appropriate times. At these junctions the BASS packages the LMHA Data with the process PrepareMHAData 4054 and when appropriate executes PostLMHAData 4056 to the Platform Upload Service or end point.

During Assessment Phases, depicted in FIG. 10, the user may trigger the beginning of the assessment activity, TriggerAssessment 4060, which is processed by OnRenderAssessment 4065, executing LogStartofSession 4070, with the necessary information for the system to serialise the session as an assessment activity since an assessment instance is initialised by the same call, referencing such instance by its AssessmentInstanceID (FIG. 12, NavigationLinkage). Every time a new question is completed by the user, OnCompleteQuestion 4080 submits the supplied answer, RequestFeedBack from the QAM 4085, and on receiving the feedback, logs the entirety of the exchange with LogResults 4087, transmitting such information to the LMHA Logger. Feedback is continuously displayed to the user by the client application, DisplayFeedback 4090 function. If the system throws a request to pause, causing PauseAssessment 4095 to fire, the LPG catches such request in

OnAttemptPauselncompleteAssessment 4100, which attempts to notify the user that the assessment may not be paused through the NotifyWarning 4102. The LPG executes LogPauseAttempt 4105, causing the LMHA Logger to SerializeResult 4106, which immediately prompts the BASS to FetchLMHAData 4107 and save such data in local storage. If the interruption is caused by the client application or system failure, then all the activity carried out by the student is safely recorded in Local Storage, including the exception description that caused the failure. This not only assists in correcting any bugs, but also in testifying on behalf of the student that the assessment activity pause was not caused as a means to evade the evaluation exercise. Should the pause not be caused by a system or app failure, and the student still insists on pausing their assessment after a warning has been dispatched 4102. The LPG through its call back OnPauselncompleteAssessment 4110, will LoglncompleteAssesment 4115; the LMHA logger will SerializeResults 4117, and the BASS will FetchLMHAData 4118, to save to Local Storage. If the assessment is completed, the LPG OnCompleteAssessment 4120 executes LogCompleteAssessment 4125, then the LMHA logger SerializeResults 4127 and the BASS executes FetchLMHAData 4128 to save to Local Storage. There is a final LPG RequestFeedback cycle 4134, which displays final results to the student 4135, which may include a digital trophy or micro certificate as part of the feedback if gradings and feedback configuration allow it. The client application displays a feedback 4140 by representing the completion of the feedback cycle.

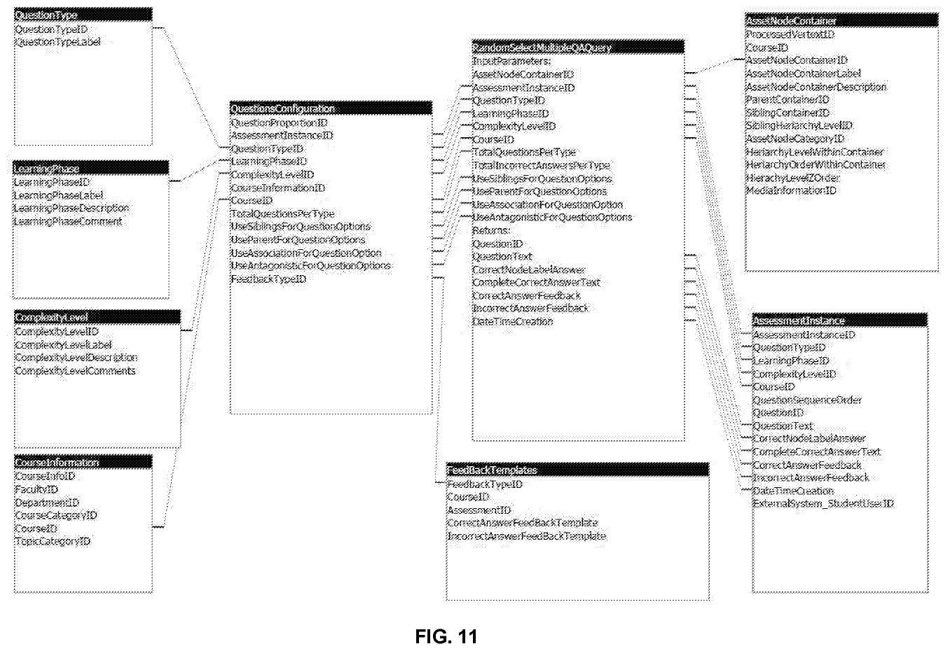

FIG. 11 illustrates a Questions and Answers Data Model (QADM) according to an embodiment herein. The Questions and Answers Data Model (QADM) shows a data model and its data relationships for the purpose of supporting the core serialisation and set of queries pertinent to the implementation of the QAM components.

FIG. 12 illustrates a Learning Monitoring and Habit Assessment (LMHA) Data Model according to an embodiment herein. The Learning Monitoring and Habit Assessment (LMHA) Data Model shows data entities and their relationships for the purpose of supporting the core serialisation and set of queries pertinent to the implementation of the LMHA components.

FIG. 13 illustrates a Topic Wizard Data Model that shows a record structure, data fields and external relationships with other core data models according to an embodiment herein. The usage of Topic Wizard Data Model becomes evident as a collector of processed data for data staging processes, as well as the output of a hybrid recommender system that filters through the text-based material based on subject, or topic, correlation significance.

FIG. 14 illustrates an Educational Skin Data Model (ESDM) according to an embodiment herein. The Educational Skin Data Model (ESDM) shows a data model and its data relationships for the purpose of supporting the core serialisation and set of queries pertinent to the implementation of the concept of an Educational Skin.

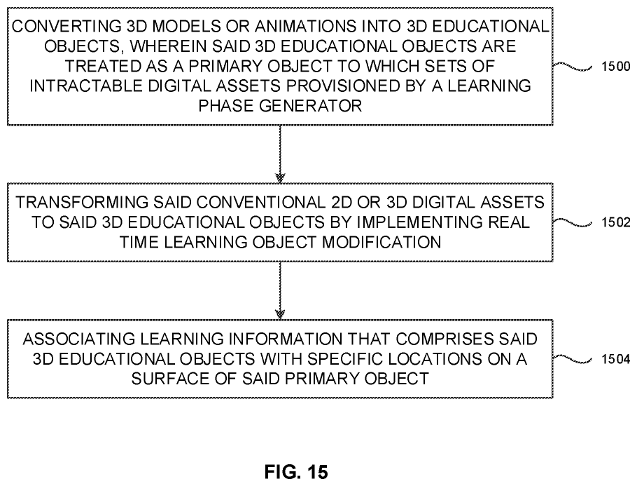

FIG. 15 is a flow diagram illustrating a method of transforming 3D models or animations into 3D educational objects for providing educational experiences addressing personalised learning paths of students/trainees. At step 1500, the Learning Phase Generator converts the 3D models or animations into the 3D educational objects. The 3D educational objects are treated as a primary object to which sets of interactable digital assets provisioned by the Learning Phase Generator. At step 1502, the central learning nodes design editor module implements real time learning object modification to transform the conventional 2D or 3D digital assets to the 3D educational objects. At step 1504, the Learning Phase Generator associates learning information that includes the 3D educational objects with specific locations on a surface of the primary object.

The Learning Phase Generator re-packages the 3D educational object with necessary associations of event triggers and media projection points to make up a contextual educational skin for the 3D educational object. The educational skin represents a virtual wrapping of the 3D educational object with a mesh of local points anywhere in proximity or contact with the 3D educational object to which events will occur through a virtual touching.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

We claim:

1. A system for automatically transforming 3D models or animations into 3D educational objects for providing educational experiences as sessions addressing personalised learning paths of students or trainees, said system comprising:
a Learning Phase Generator that converts said 3D models or animations into said 3D educational objects, wherein said 3D educational objects are treated as a primary object to which sets of interactable digital assets are provisioned by the Learning Phase Generator; and
a central learning nodes design editor module that implements real time learning object modification that aids in the transformation of said conventional 2D or 3D digital assets to said 3D educational objects,
said Learning Phase Generator associates learning information that comprises said 3D educational objects with specific locations on a surface of said primary object,
wherein said Learning Phase Generator re-packages said 3D educational object with necessary associations of event triggers and media projection points to make up a contextual educational skin for said 3D educational object, and wherein said educational skin represents a virtual wrapping of said 3D educational object with a mesh of local points anywhere in proximity or contact with said 3D educational object to which said students or trainees interaction, including virtual touching, will cause pre-configured events to occur in the appropriate manner

2. The system as claimed in claim 1,
wherein said virtual touching represents touching an augmented reality or a virtual reality projection at a specific point or user input that will produce a reaction for said event, and
wherein said educational skin represents projecting context based information in any digital format that is contextually relevant to such situation, whereby said students or trainees interact with specific hot spots within the nominated regions of said 3D educational object to activate the functioning of configured components as related to a learning phase.

3. The system as claimed in claim 1, wherein said session comprises augmented reality or virtual reality projection of said 3D educational objects, wherein said 3D educational objects comprises interactive educational materials that is used to strengthen a learning experience of said students or trainees.

4. The system as claimed in claim 1, comprising
a digital assets query engine that recurses through the text-based definition of a 3D object to capture defined individual vertex offsets; UV mapping for each texture coordinate vertex; faces that organise polygons into the object's list of vertices; texture vertices; vertex normals; and any other data as peripheral in sequential order and automatically classify names of such nodes to provide the means to instantiate said educational skin on said 3D Model; and
a question and answers module that enables an administrator or a content manager to rely on their designated ranges of gradings, to configure the run-time logic to statistically trigger said system produced contextually valid evaluation statements at run-time in response to each answer supplied by said student or trainee involved in completing an assessment activity

5. The system as claimed in claim 1, comprising
a learning process evaluator that supports requirements of autodidacticism by reinforcing learning through access to past learning decisions as personal progress reports or video interactives and fulfilling requirements of utilising discovery or exploration in both directed and undirected fashions.

6. The system as claimed in claim 1, comprising:
a natural language processing and hybrid recommender module that assists an educator to automatically generate classification metadata for complex text material across a complete set of course resources associated with said 3D educational objects, wherein said natural language processing and hybrid recommender module is configured to identify metadata and associated subjects and topics of interest, which is extracted from said text material to add as primary or peripheral learnings to enhance specific learning experiences of students or trainees; and
a visual object processing and classification module that assists said educator to automatically generate the classification metadata for complex video footage for said complete set of course resources.

7. The system as claimed in claim 1, comprising:
a learning phase evaluator module that provides students or trainees with evaluations on their progress at any point of a learning cycle as generated by sub components of a question and answers module, wherein said learning phase evaluator module generates micro certification for said students or trainees based on their learning cycle, which is symbolised by digital trophies and awards that can be visible to other students or trainees.

8. The system as claimed in claim 1, comprising:
a learning monitoring and habit assessment module that generates said augmented reality or said virtual reality exploration or navigation maps that can be extrapolated to quantify relevant variables attached to measure the degree to which knowledge or skills have been transferred through said 3D objects, wherein said degree comprises a report for tracking a progress of said students or trainees and overall success of a course.

9. The system as claimed in claim 1, wherein said 3D educational objects comprises educational materials, different classifications of said educational materials and related video footage, wherein said 3D educational objects can be selected by said students or trainees through said various forms of virtual touching, as configured by said administrator or content manager

10. A method of transforming 3D models or animations into 3D educational objects for providing educational experiences addressing personalised learning paths of students or trainees, said method comprising:
converting (1500) said 3D models or animations into said 3D educational objects, wherein said 3D educational objects are treated as a primary object to which sets of interactable digital assets provisioned by the Learning Phase Generator;
transforming (1502) said conventional 2D or 3D digital assets to said 3D educational objects by implementing real time learning object modification; and
associating (1504) learning information that comprises said 3D educational objects with specific locations on a surface of said primary object.
